(19) United States
(12) Patent Application Publication
(10) Pub. No.: US 2010/0159106 A1
(43) Pub. Date: Jun. 24, 2010

(54) Process for the Preparation of Ready to Eat and Ready to Cook Food Snacks

(76) Inventor: Ghanshyam Das Agrawal, Calcutta (IN)

Correspondence Address: THE WEBB LAW FIRM, P.C., 700 KOPPERS BUILDING, 436 SEVENTH AVENUE, PITTSBURGH, PA, 15219, US

(21) Appl. No.: 12/339,915

(22) Filed: Dec. 19, 2008

(51) Int. Cl. A23L 3/44; A23C 1/08; A23B 7/16; A23L 3/005; A23L 1/317; A23L 1/212

(52) U.S. Cl. 426/582; 426/385; 426/310; 426/615; 426/640; 426/646

(57) ABSTRACT

A process for preparation of food snack comprising steps of soaking raw cereals in water, boiling, freeze drying followed by addition of dry ingredients. A process for preparation of vegetable preparation comprising steps of boiling of vegetable/cereal followed by freeze drying and addition of dry ingredients. A process for preservation of vegetables comprising steps of soaking, blanching/boiling and freeze drying followed by application of a layer. Further, this invention is directed to paneer preparation comprising of paneer, vegetable, spices and flavourings. A curry masala preparation comprising of vegetable, spices and flavourings. A KOFTA preparation comprising of KOFTA, vegetable, spices and flavourings. The ingredients are freeze, dried wherever required.

### FIELD OF INVENTION

This invention relates to a process for the preparation of food snack, instant cooking vegetable preparation and preservation of vegetables, and PANEER food preparations, curry masala preparations and KOFTA food preparations. This invention particularly relates to a process for the preparation of a ready to eat healthy food snack, a process for preparation of instant cooking vegetable preparation, a process for preservation of blanched/boiled & freeze dried vegetables, Indian PANEER (COTTAGE CHEESE) food preparations, a ready to cook instant cooking Indian curry masala preparations and a ready to cook instant cooking Indian KOFTA (vegetable &/or cheese balls in curry) food preparations.

### BACKGROUND OF INVENTION

Ready to eat food products are known in the art and are gradually becoming of importance as it saves time and is easily available. The process for preparing ready to eat food snack consists in first preparing the product by frying or roasting, extruding etc. Later on spices and taste enhancers are added therein. The mixed product is then packed in multilayer laminate pouches, which is then sealed.

Several disadvantages are associated with ready to eat food snacks is that of drawbacks associated with frying such as production of acrylamide and increase of total polar materials in frying oil, which are very bad for health. The cooked food snack carries these harmful agents Burn oil reacts with oxygen contained in atmosphere and also with the food ingredients. Yet another disadvantage is of the smell associated with the food product. Yet another disadvantage is that the original taste value of the fried snack food is affected.

Ready to cook edible preparations are known in the art. However, in distinction to instant cooking preparation of the present invention, the ready to cook preparations requires a cooking cycle. The instant cooking preparation of the present invention requires only a period of approximately 2-5 minutes to cook.

Reference is made herein to ladies finger (okara) as by way of example. Okara are first soaked in water, blanched/boiled and freeze dried. A disadvantage associated with such a process is that after storage for a certain period, the okara become rancid. Such a rancidity is due to the reason that, the pores of the okara are exposed and subjected to atmospheric oxidation.

It is known that vegetables contain oil. Thus, by subjecting the vegetable to the aforesaid steps, the oil is exposed to atmospheric oxidation which is responsible for rancidity.

Ready to eat Indian food preparations are known. However, ready to cook Indian food preparations are not known in the art.

Ready to eat Indian food preparations are known. However, ready to cook Indian curry masala preparations are not known in the art.

### OBJECTS OF THE INVENTION

An object of this invention is to propose a process for the preparation of a ready to eat healthy food snack.

Another object of this invention is to propose a process for the preparation of a ready to eat healthy food snack which is no longer fried.

Still another object of this invention is to propose a process for the preparation of a ready to eat healthy food snack which has a taste value.

Yet another object of this invention is to propose a process for the preparation of a ready to eat healthy food snack which does not have oil burning by products.

An object of this invention is to propose a process for preparation of instant cooking vegetable preparation.

Another object of this invention is to propose a process for preparation of instant cooking vegetable preparation which requires only a period of approximately 2-5 minutes to cook.

Still another object of this invention is to propose a process for preparation of instant cooking vegetable preparation which is tasty.

Yet another object of this invention is to propose a process for preparation of instant cooking vegetable preparation which has the fragrance of a normal cooked vegetable.

An object of this invention is to propose a process for preservation of blanched/boiled & freeze dried vegetables.

Another object of this invention is to propose a process for preservation of blanched/boiled & freeze dried vegetables, which substantially avoids rancidity.

Still another object of this invention is to propose a process for preservation of blanched/boiled & freeze dried vegetables, which is efficient.

An object of this invention is to propose a ready to cook instant cooking Indian PANEER (COTTAGE CHEESE) food preparations.

Another object of this invention is to propose a ready to cook instant cooking Indian PANEER (COTTAGE CHEESE) food preparations, which has after cooking, the same flavor & texture as an originally cooked food.

An object of this invention is to propose a ready to cook instant cooking Indian curry masaa preparations.

Another object of this invention is to propose a ready to cook instant cooking Indian curry masala preparations, which has after cooking, the same flavor & texture as an originally cooked food.

An object of this invention is to propose a ready to cook instant cooking Indian KOFTA (vegetable &/or cheese balls in curry) food preparations.

Another object of this invention is to propose a ready to cook instant cooking Indian KOFTA food preparations, which has after cooking, the same flavor & texture as an originally cooked food.

Further objects and advantages of this invention will be more apparent from the ensuing description.

### SUMMARY OF THE INVENTION

According to this invention there is provided a process for the preparation of a ready to eat healthy food snack comprising steps of:—
soaking raw cereals in water
boiling the soaked cereals in water
Mixing of spices and taste enhancers with boiled cereals
Blast freezing the product
freeze drying the frozen food product
adding dry ingredients thereto followed by packing.

Further, according to this invention there is provided a process for preparation of instant cooking vegetable preparation comprising steps of
boiling of vegetable/cereal in water
freeze drying the cooked food product
addition of dry ingredients thereto.

Further, according to this invention there is provided a process for the preservation of blanched/boiled & freeze dried vegetables which comprises in the steps of soaking the vegetables, blanching/boiling and freeze drying the vegetables characterized by the steps of applying a barrier layer to the exposed surface of the vegetable and thereby closing the pores.

Further, according to this invention there is provided a ready to cook instant cooking Indian PANEER (COTTAGE CHEESE) preparation comprising of:
a. 50 to 90% by wt. of PANEER (COTTAGE CHEESE),
b. 10 to 40% by wt. of Indian vegetable, spices such as onion, tomato, garlic & ginger,
c. 5 to 30% by wt. of flavorings.

Further, according to this invention there is provided a ready to cook instant cooking Indian curry masala preparation comprising of:
a. 40 to 80% by wt. of Indian vegetable, spices such as onion, tomato, garlic & ginger,
b. 20 to 60% by wt. of flavorings.

Further, according to this invention there is provided a ready to cook instant cooking Indian KOFA preparations comprising of:
a. 50 to 90% by wt. of KOFTA,
b. 10 to 40% by wt. of Indian vegetable, spices such as onion, tomato, garlic & ginger,
c. 5 to 30% by wt. of flavorings.

### DETAILED DESCRIPTION OF THE INVENTION

This invention provides a process for the preparation of a ready to eat food snack which comprises of soaking raw cereal such as chick pea in water at temperature such as 29-35° C. for such as 2-10 hours. This is followed by boiling such as for 20-30 minutes, and draining the water for example up to 30 minutes and subsequently cooling off. This is followed by mixing of spices and taste enhancers. Thereafter, the boiled chick pea is subjected to rapid freezing for example up to −20° C. followed by drying in a drier chamber having vacuum such as less than one torr wherein the chick pea is slowly heated so as to raise its temperature for example maximum up to 70° C. This is simultaneously cooled for example up to −40° C., where the water vapor gets deposited. This requires maintenance of pressure at for example 1 torr.

The above said process continues for 2-8 hours, after which the treated chick pea is taken out and mixed with dry ingredients such as tomatoes, garlic and onion. Such ingredients are separately freeze dried. Thereafter, salt and spices are added. Finally, it is packed in air tight pouches.

Reference to chick-pea has been made hereinabove is only by way of example and without intending to imply any limitation on the scope of the invention.

In accordance with this invention, chick-pea is first soaked in water and then subjected to the step of boiling. The boiled chick-pea is then mixed with spices and taste enhancers and subjected to step of freeze drying. It has been found that if the step of freeze drying is not effected after the step of boiling, then the size of chick-pea is reduced and the texture is affected.

Again, the invention provides a process for the preparation of an instant cooking vegetable preparation comprises of cutting of normal vegetables such as peas, green beans or cereals. In case of cereal such as chick pea and lentil, the same is subjected to soaking in water at temperature such as 29-35° C. for such as 2-10 hours. This is followed by partial cooking/boiling such as for 20-30 minutes draining the water for example up to 30 minutes and subsequently cooling off. Thereafter, the boiled vegetable/cereal is subjected to rapid freezing for example up to −20° C. followed by drying in a drier chamber having vacuum such as less than one torr wherein the vegetable/chick pea is slowly heated so as to raise its temperature for example maximum up to 70° C. This is simultaneously cooled for example up to 40° C., where the water vapour gets deposited. This requires maintenance of pressure at for example 1 torr.

The above said process continues for 2-8 hours after which the treated chick pea/vegetable is removed. Thereafter, it is mixed with taste enhancers or garnishing. The taste enhancer could be any enhancer known as such in the art. In accordance with one embodiment, the taste enhancer comprises cut, partially cooked, frozen and dried vegetables, such as tomato, garlic or onion.

The process further comprises addition of flavourings, spices, pepper, salt and oil.

Specially, in accordance with this invention, the preparation comprises an instant cooking vegetable preparation in distinction to a ready to eat preparation.

In accordance with this invention, chick-pea is first soaked in water and then subjected to the step of boiling. The boiled chick-pea is then subjected to step of freeze drying. It has been found that if the step of freeze drying is not effected after the step of boiling, then the size of chick-pea is reduced and the texture is affected.

Further, according to this invention there is provided a process for the preservation of blanched/boiled & freeze dried vegetables which comprises in the steps of soaking the vegetables, blanching/boiling & freeze drying the vegetables and applying a barrier layer to the exposed surface of the vegetable and thereby closing the pores.

The vegetables are soaked in water, blanched/boiled & freeze dried in a manner as described herein above.

Specifically, in accordance with this invention, a barrier layer is applied to exposed surface of the vegetables. Such a barrier layer can comprise a coating or film of edible oil/edible wax such as groundnut oil.

For the purpose, the vegetables and edible oil/wax are mixed thoroughly in a mixer. By applying such a barrier layer, the pores are closed and barrier layer no longer allows the surface to be exposed to atmospheric oxidation.

By way of example oil is added to the extent of 2 to 20% by dry weight of vegetables. If less than 2% by weight is added, a suitable layer is not formed on the surface of the vegetables. However, if more than 20% is added, then no additional beneficial results are achieved.

This invention also provides a ready to cook instant cooking Indian PANEER (COTTAGE CHEESE) preparations comprising of the following:

50 to 90% by wt. of freeze dried PANEER (COTTAGE CHEESE); 10 to 40% by wt. of freeze dried or otherwise dried vegetable, spices such as onion, tomato, garlic & ginger, 5 to 30% by wt. of flavorings such as condiments, spices, salt, preservatives, added flavors, emulsifiers, thickeners, potato powder, powdered dry fruits, milk products and other such ingredients.

In accordance with this invention the food preparation comprises 50 to 90% by wt. of PANEER (COTTAGE CHEESE), which are freeze dried.

10 to 40% by wt. of freeze dried vegetable, spices such as onion, tomato, garlic & ginger.

5 to 30% by wt. of flavorings such as condiments, spices, salt, preservatives, added flavors, emulsifiers, thickeners, potato powder, milk products, powdered dry fruits and other such ingredients.

Further, this invention provides a ready to cook instant cooking Indian curry masala preparation comprising of the following:

1. 40 to 80% by wt. of freeze dried vegetable, spices such as onion, tomato, garlic & ginger.
2. 20 to 60% by wt. of flavorings such as condiments, spices, salt, preservatives, added flavors, emulsifiers, thickeners, potato powder, milk products, dry fruit powder and other such ingredients.

This invention provides a ready to cook instant cooking Indian KOFTA (vegetable &/or cheese balls in curry) preparations comprising of the following:

50 to 90% by wt. of freeze dried KOPTA (made of vegetables/potato/cottage cheese and some cereal powders); 10 to 40% by wt. of freeze dried vegetable, spices such as onion, tomato, garlic & ginger and 5 to 30% by wt. of flavorings such as condiments, spices, salt, preservatives, added flavors, emulsifiers, thickeners, potato powder, powdered dry fruits, milk products and other such ingredients.

In accordance with this invention the food preparation comprises 50 to 90% by wt. of KOFTA, which are freeze dried.

10 to 40% by wt. of freeze dried vegetable, spices such as onion, tomato, garlic & ginger.

5 to 30% by wt. of flavorings such as condiments, spices, salt, preservatives, added flavors, emulsifiers, thickeners, potato powder, milk products, powdered dry fruits and other such ingredients.

It is to be noted that the present invention is susceptible to modifications, adaptations and changes by those skilled in the art. Such variant embodiments employing the concepts and features of this invention are intended to be within the scope of the present invention, which is further set forth under the following claims:—

1-27. (canceled)

28. A process for the preparation of a ready to eat healthy food snack comprising the steps of:
a. soaking raw cereals and/or vegetables in water;
b. boiling the soaked cereals and/or vegetables in water to form a boiled food product;
c. freeze drying the boiled food product;
d. adding dry ingredients thereto to form the food snack; and
e. packaging the food snack.

29. The process as claimed in claim 28, wherein the raw cereals and/or vegetables are soaked in water at approximately 29-35° C. for about 2-10 hours.

30. The process as claimed in claim 28, wherein the boiled food product is mixed with spices, salt and taste enhancers.

31. The process as claimed in claim 30, wherein the boiled food product is subjected to rapid freezing at a temperature of up to −20° C. followed by drying in a drier chamber.

32. The process as claimed in claim 31, wherein the drying is carried out at a vacuum of less than one torr by slowly heating to a maximum temperature of up to 70° C.

33. The process as claimed in claim 32, wherein after drying, cooling is done at a temperature of up to 40° C. and a pressure of approximately one torr.

34. The process as claimed in claim 33, comprising the step of adding freeze drying ingredients to the treated vegetables followed by mixing with salt and spices prior to the step of packaging the food snack.

35. A process for preparation of instant cooking vegetable preparation comprising the steps of:
boiling of vegetable/cereal in water to form a cooked food product;
freeze drying the cooked food product; and
adding dry ingredients thereto.

36. The process as claimed in claim 35, wherein the vegetable is selected from the group consisting of peas and green beans and the cereal is selected from the group consisting of chick peas and lentils.

37. The process as claimed in claim 36, wherein the cereal is subjected to soaking in water at a temperature of approximately 29-35° C. for about 2-10 hours.

38. The process as claimed in claim 28, wherein the boiling is carried out for about 20-30 minutes.

39. The process as claimed in claim 35, wherein the boiling is carried out for about 20-30 minutes.

40. The process as claimed in claim 39, wherein the boiled vegetable/cereal is subjected to rapid freezing at a temperature of up to −20° C. followed by drying in a drier chamber.

41. The process as claimed in claim 40, wherein the drying is carried out at a vacuum of less than approximately one torr by slowly heating to a maximum temperature of up to 70° C.

42. The process as claimed in claim 41, comprising adding at least one of taste enhancers or garnishings followed by mixing with at least one of flavorings, spices, pepper, salt and oil.

43. A process for the preservation of blanched/boiled and freeze dried vegetables which comprises the steps of soaking the vegetables;
blanching/boiling and freeze drying the vegetables; and applying a barrier layer to the exposed surface of the vegetables and thereby closing the pores of the vegetables.

44. The process for the preservation of blanched/boiled and freeze dried vegetables as claimed in claim 43, wherein the barrier layer can comprise a coating or film of edible oil/edible wax.

45. The process for the preservation of blanched/boiled and freeze dried vegetables as claimed in claim 44, wherein the oil/wax is added in an amount of approximately 2-20% by dry weight of vegetables.

46. The process for the preservation of blanched/boiled and freeze dried vegetables as claimed in claim 43, wherein the application of the barrier layer is carried out by thoroughly mixing the vegetables and the barrier layer in a mixer.

47. A ready to cook instant cooking Indian PANEER (COTTAGE CHEESE) preparation comprising:
a. 50 to 90% by weight of PANEER (COTTAGE CHEESE),
b. 10 to 40% by weight of vegetables and spices; and
c. 5 to 30% by weight of flavorings.

48. A ready to cook instant cooking Indian PANEER (COTTAGE CHEESE) preparation as claimed in claim 47, wherein the PANEER (COTTAGE CHEESE) is freeze dried.

49. A ready to cook instant cooking Indian PANEER (COTTAGE CHEESE) preparation as claimed in claim 48, wherein the vegetables and spices are freeze dried.

50. A ready to cook instant cooking Indian curry masala preparation comprising:
a. 40 to 80% by weight of vegetables and spices; and
b. 20 to 60% by weight of flavorings.

51. A ready to cook instant cooking Indian curry masala preparation as claimed in claim 50, wherein the vegetables and spices are freeze dried.

52. A ready to cook instant cooking Indian KOFTA preparation comprising:
a. 50 to 90% by weight of KOFTA;
b. 100 to 40% by weight of vegetables and spices; and
c. 5 to 30% by weight of flavorings.

53. A ready to cook instant cooking KOFTA preparation as claimed in claim 52, wherein the KOFTA is freeze dried.

54. A ready to cook instant cooking KOFTA preparation as claimed in claim 52, wherein the vegetables and spices are freeze dried.

55. A ready to cook instant cooking KOFTA preparation as claimed in claim 52, wherein said flavorings are selected from the group consisting of condiments, spices, salt, preservatives, added flavors, emulsifiers, thickeners, potato powder, milk products, and powdered dry fruits.
